(19) United States
(12) Patent Application Publication
(10) Pub. No.: US 2026/0080302 A1
(43) Pub. Date: Mar. 19, 2026

(54) MACHINE LEARNING BASED COMPUTING SYSTEM AND METHOD FOR GENERATING DECISIONS CORRESPONDING TO PROCESSES IN ORGANIZATIONS

(71) Applicant: Exafluence Inc USA, South Brunswick, NJ (US)

(72) Inventor: Ravikiran Dharmavaram, North Brunswick, NJ (US)

(21) Appl. No.: 18/888,293

(22) Filed: Sep. 18, 2024

(51) Int. Cl. G06N 20/00

(52) U.S. Cl. CPC G06N 20/00

(57) ABSTRACT

A machine learning based computing system for generating decisions corresponding to processes in organizations. The ML-based computing system is configured to: receive data associated with experiments, from electronic devices associated with users; analyze first data associated with first experiments, second data associated with second experiments, and third data associated with third experiments; generate second insights associated with second experiments, based on the analyzed second data associated with the second experiments by ML models; generate third insights associated with the third experiments, based on analyzed third data associated with the third experiments by simulation based models; synthesize first insights retrieved from historical data, the second insights generated from the second experiments by the ML models, and the third insights generated from the third experiments by the simulation based models; generate the decisions based on synthesization of first, second insights, and third insights; provide an output of decisions to user interfaces.

### FIELD OF INVENTION

Embodiments of the present disclosure relate to machine learning based (ML-based) computing systems, and more particularly relates to a ML-based computing method and system for generating one or more decisions corresponding to one or more processes in one or more organizations.

### BACKGROUND

Decision-making is a process of selecting a course of action or choosing from among various alternatives based on a thorough evaluation of available information, preferences, and objectives. The decision-making process involves assessing potential outcomes and consequences associated with each option to make a reasoned and informed choice. Decision-making occurs at various levels, from routine daily choices to complex strategic decisions in organizational and personal contexts. The decision-making process typically involves identifying the problem or opportunity, gathering relevant information, analyzing alternatives, considering constraints, and making a final determination. An effective decision-making is crucial for achieving goals, solving problems, and navigating uncertainties in a wide range of situations.

The decision-making process in an organization is a complex and crucial process that involves selecting a course of action from among multiple alternatives to achieve organizational goals. There are different decision-making levels in an organization aspect, which includes at least one of: strategic decisions, tactical decisions, and operational decisions.

The strategic decisions are high-level decisions that impact an overall direction of the organization. These strategic decisions are typically made by top-level executives and affect the organization's long-term goals and objectives. The tactical decisions are mid-level decisions that focus on implementing strategies formulated at the strategic level. These tactical decisions are made by middle managers and involve resource allocation and coordination. The operational decisions are day-to-day decisions that deal with routine tasks and activities. Frontline managers and employees are involved in operational decision-making processes.

A manual decision-making relying on human judgement without aid of automated tools and systems. Though, the manual decision-making is essential for organizational success, the manual decision-making has drawbacks. The manual decision-making is susceptible to individual biases, personal opinions, and emotions. This can lead to subjective judgments that may not always align with rational or objective criteria. Further, humans have limited cognitive processing capacity. When faced with a large amount of data or complex information, the humans may struggle to analyze and consider all relevant factors, leading to suboptimal decisions.

Further, the manual decision-making may be inconsistent, varying based on factors including at least one of: mood, time pressure, and external influences. However, lack of consistency by the manual decision-making may result in unpredictable decision outcomes. Further, manual decision-makers may not have timely access to all relevant information. Delay in gathering and processing data may impact the quality and timeliness of the decisions. The humans are prone to errors, including cognitive biases, judgment errors, and mistakes in data interpretation. These errors may have significant consequences, especially in critical decision-making situations.

Further, the manual decision-making may struggle to scale efficiently, particularly when dealing with a large volume of decisions or complex scenarios. This limitation becomes more apparent as organizational complexity increases. Further, in the era of big data, the manual decision-making may struggle to process and extract meaningful insights from vast datasets. The manual decision-making may require automated tools for handling and analyzing large volumes of data efficiently. Further, collaborative decision-making may be challenging without shared tools or systems. Manual methods may hinder effective communication and coordination among decision-makers, leading to delays and misunderstandings.

Hence, there is a need for an improved machine learning based (ML-based) computing system and method for generating one or more decisions corresponding to one or more processes in one or more organizations, in order to address the aforementioned issues.

### SUMMARY

This summary is provided to introduce a selection of concepts, in a simple manner, which is further described in the detailed description of the disclosure. This summary is neither intended to identify key or essential inventive concepts of the subject matter nor to determine the scope of the disclosure.

In accordance with an embodiment of the present disclosure, a machine learning based (ML-based) computing system for generating one or more decisions corresponding to one or more processes in one or more organizations, is disclosed. The machine learning based (ML-based) computing system includes one or more hardware processors and a memory. The memory is coupled to the one or more hardware processors. The memory comprises a plurality of subsystems in form of programmable instructions executable by the one or more hardware processors. The plurality of subsystems comprises an input receiving subsystem configured to receive one or more data associated with one or more experiments corresponding to the one or more processes, from one or more electronic devices associated with one or more users. The one or more data comprise at least one of: one or more first data associated with one or more first experiments corresponding to the one or more processes, one or more second data associated with one or more second experiments corresponding to the one or more processes, and one or more third data associated with one or more third experiments corresponding to the one or more processes. The one or more first data are historical data comprising one or more first insights associated with the one or more first experiments corresponding to the one or more processes.

The plurality of subsystems further comprises a data analyzing subsystem configured to analyze at least one of: the one or more first data associated with the one or more first experiments, the one or more second data associated with the one or more second experiments, and the one or more third data associated with the one or more third experiments.

The plurality of subsystems further comprises an insight generation subsystem configured to generate one or more second insights associated with the one or more second experiments corresponding to the one or more processes, based on the analyzed one or more second data associated with the one or more second experiments by one or more machine learning models. The insight generation subsystem is further configured to generate one or more third insights associated with the one or more third experiments corresponding to the one or more processes, based on the analyzed one or more third data associated with the one or more third experiments by one or more simulation based models.

The plurality of subsystems further comprises an insight synthesizing subsystem configured to synthesize at least one of: the one or more first insights retrieved from the historical data, the one or more second insights generated from the one or more second experiments corresponding to the one or more processes by the one or more machine learning models, and the one or more third insights generated from the one or more third experiments corresponding to the one or more processes by the one or more simulation based models.

The plurality of subsystems further comprises a decision generation subsystem configured to generate the one or more decisions corresponding to the one or more processes based on synthesization of at least one of: the one or more first insights retrieved from the historical data, the one or more second insights generated from the one or more second experiments corresponding to the one or more processes by the one or more machine learning models, and the one or more third insights generated from the one or more third experiments corresponding to the one or more processes by the one or more simulation based models.

The plurality of subsystems further comprises an output subsystem configured to provide an output of the one or more decisions corresponding to the one or more processes to one or more user interfaces associated with the one or more electronic devices of the one or more users in the one or more organizations.

In an embodiment, the one or more second data associated with the one or more second experiments comprise one or more real time data corresponding to the one or more processes. The one or more real time data are inputted to the one or more machine learning models to generate one or more first prediction results associated with the one or more second insights corresponding to the one or more processes. The one or more third data associated with the one or more third experiments comprise the one or more real time data corresponding to the one or more processes. The one or more real time data are inputted to the one or more simulation based models to generate one or more second prediction results associated with the one or more third insights corresponding to the one or more processes.

In another embodiment, in generating the one or more second insights associated with the one or more second experiments corresponding to the one or more processes, the one or more machine learning models in the insight generation subsystem are configured to: (a) obtain the analyzed one or more second data associated with the one or more second experiments corresponding to the one or more processes; (b) compare the analyzed one or more second data associated with the one or more second experiments corresponding to the one or more processes, with one or more predetermined data associated with the one or more processes for which the one or more decisions are generated; (c) determine whether the analyzed one or more second data associated with the one or more second experiments corresponding to the one or more processes reach one or more predefined threshold values associated with the one or more predetermined data associated with the one or more processes, by the one or more machine learning models; and (d) generate the one or more second insights associated with the one or more second experiments corresponding to the one or more processes when the analyzed one or more second data associated with the one or more second experiments corresponding to the one or more processes reach the one or more predefined threshold values associated with the one or more predetermined data associated with the one or more processes.

In yet another embodiment, in generating the one or more third insights associated with the one or more third experiments corresponding to the one or more processes, the one or more simulation based models in the insight generation subsystem are configured to: (a) obtain the analyzed one or more third data associated with the one or more third experiments corresponding to the one or more processes; (b) process the one or more simulation based models based on the analyzed one or more third data associated with the one or more third experiments corresponding to the one or more processes; (c) generate one or more simulation results associated with the one or more third insights by processing the analyzed one or more third data; and (d) validate the generated one or more simulation results associated with the one or more third insights by comparing the generated one or more simulation results associated with the one or more third insights, with one or more actual simulation results associated with one or more actual insights corresponding to the one or more third data.

In yet another embodiment, the one or more machine learning models are further configured to: (a) assign one or more weights to the generated one or more decisions corresponding to the one or more processes; and (b) select an optimal decision corresponding to the one or more processes based on an optimal weight assigned to the generated one or more decisions corresponding to the one or more processes.

In yet another embodiment, the plurality of subsystems further comprises a training subsystem configured to train the one or more machine learning models on the one or more second data to generate the one or more second insights associated with the one or more second experiments corresponding to the one or more processes. For training the one or more machine learning models on the one or more second data, the training subsystem is configured to: (a) obtain the one or more second data associated with the one or more second experiments corresponding to the one or more processes; (b) select one or more features associated with the one or more second data for training the one or more machine learning models based on one or more feature engineering processes; (c) train the one or more machine learning models to correlate the one or more features associated with the one or more second data, with one or more prestored results related to the one or more second experiments corresponding to the one or more processes, based on one or more hyperparameters; (d) generate the one or more second insights associated with the one or more second experiments corresponding to the one or more processes based on the trained one or more machine learning models; (e) validate the one or more machine learning models based on one or more validation datasets; and (f) adjust the one or more hyperparameters to fine-tune the one or more machine learning models based on one or more results of validation of the one or more machine learning models.

In yet another embodiment, the generated one or more decisions corresponding to the one or more processes are configured to be stored in one or more databases.

In yet another embodiment, the generated one or more decisions are dynamically optimized based on one or more feedbacks received on the one or more first data associated with the one or more first experiments using a feedback subsystem. For dynamically optimizing the generated one or more decisions, the feedback subsystem is configured to: (a) validate the one or more feedbacks received on the one or more first data associated with the one or more first experiments, by comparing one or more values associated with the one or more feedbacks with one or more predetermined values; (b) select the validated one or more feedbacks received on the one or more first data based on the comparison of the one or more values associated with the one or more feedbacks with the one or more predetermined values; and (c) optimize the generated one or more decisions based on the selection of the validated one or more feedbacks received on the one or more first data associated with the one or more first experiments.

In yet another embodiment, the generated one or more decisions are dynamically optimized by applying the generated one or more third insights as one or more inputs to the one or more simulation based models. The generated one or more third insights are continuously applied as the one or more inputs until the generated one or more decisions are dynamically optimized.

In an aspect, a machine learning based (ML-based) computing method for generating one or more decisions corresponding to one or more processes in one or more organizations, is disclosed. The machine learning based (ML-based) computing method comprises receiving, by one or more hardware processors, one or more data associated with one or more experiments corresponding to the one or more processes, from one or more electronic devices associated with one or more users. The one or more data comprise at least one of: one or more first data associated with one or more first experiments corresponding to the one or more processes, one or more second data associated with one or more second experiments corresponding to the one or more processes, and one or more third data associated with one or more third experiments corresponding to the one or more processes. The one or more first data are one or more historical data comprising one or more first insights associated with the one or more first experiments corresponding to the one or more processes.

The machine learning based (ML-based) computing method further comprises analyzing, by the one or more hardware processors, at least one of: the one or more first data associated with the one or more first experiments, the one or more second data associated with the one or more second experiments, and the one or more third data associated with the one or more third experiments.

The machine learning based (ML-based) computing method further comprises generating, by the one or more hardware processors, one or more second insights associated with the one or more second experiments corresponding to the one or more processes, based on the analyzed one or more second data associated with the one or more second experiments by one or more machine learning models.

The machine learning based (ML-based) computing method further comprises generating, by the one or more hardware processors, one or more third insights associated with the one or more third experiments corresponding to the one or more processes, based on the analyzed one or more third data associated with the one or more third experiments by one or more simulation based models.

The machine learning based (ML-based) computing method further comprises synthesizing, by the one or more hardware processors, at least one of: the one or more first insights retrieved from the historical data, the one or more second insights generated from the one or more second experiments corresponding to the one or more processes by the one or more machine learning models, and the one or more third insights generated from the one or more third experiments corresponding to the one or more processes by the one or more simulation based models.

The machine learning based (ML-based) computing method further comprises generating, by the one or more hardware processors, the one or more decisions corresponding to the one or more processes based on synthesization of at least one of: the one or more first insights retrieved from the historical data, the one or more second insights generated from the one or more second experiments corresponding to the one or more processes by the one or more machine learning models, and the one or more third insights generated from the one or more third experiments corresponding to the one or more processes by the one or more simulation based models.

The machine learning based (ML-based) computing method further comprises providing, by the one or more hardware processors, an output of the one or more decisions corresponding to the one or more processes to one or more user interfaces associated with the one or more electronic devices of the one or more users in the one or more organizations.

In another aspect, a non-transitory computer-readable storage medium having instructions stored therein that, when executed by a hardware processor, causes the processor to perform method steps as described above.

To further clarify the advantages and features of the present disclosure, a more particular description of the disclosure will follow by reference to specific embodiments thereof, which are illustrated in the appended figures. It is to be appreciated that these figures depict only typical embodiments of the disclosure and are therefore not to be considered limiting in scope. The disclosure will be described and explained with additional specificity and detail with the appended figures.

### BRIEF DESCRIPTION OF DRAWINGS

The disclosure will be described and explained with additional specificity and detail with the accompanying figures in which:

FIG. 1 is a block diagram illustrating a computing environment with a machine learning based (ML-based) computing system for generating one or more decisions corresponding to one or more processes in one or more organizations, in accordance with an embodiment of the present disclosure;

FIG. 2 is a detailed view of the ML-based computing system for generating the one or more decisions corresponding to the one or more processes in the one or more organizations, in accordance with another embodiment of the present disclosure;

FIG. 3 is an exemplary user interface view depicting information associated with the one or more processes (i.e., studies) for which the one or more decisions to be generated, in accordance with an embodiment of the present disclosure;

FIG. 4 is an exemplary user interface view depicting the one or more processes, in accordance with an embodiment of the present disclosure;

FIG. 5 is an exemplary user interface view depicting one or more experiments corresponding to the one or more processes, in accordance with an embodiment of the present disclosure;

FIG. 6 is an exemplary user interface view depicting the one or more experiments running for generating the one or more decisions for the one or more processes, in accordance with an embodiment of the present disclosure;

FIG. 7 is an exemplary user interface view depicting one or more results including the one or more decisions for the one or more processes based on the one or more experiments, in accordance with an embodiment of the present disclosure;

FIG. 8 is an exemplary user interface view depicting detailed information associated with the one or more results including the one or more decisions for the one or more processes, in accordance with an embodiment of the present disclosure; and

FIG. 9 is a flow chart illustrating a machine-learning based (ML-based) computing method for generating the one or more decisions corresponding to the one or more processes in the one or more organizations, in accordance with an embodiment of the present disclosure.

Further, those skilled in the art will appreciate that elements in the figures are illustrated for simplicity and may not have necessarily been drawn to scale. Furthermore, in terms of the construction of the device, one or more components of the device may have been represented in the figures by conventional symbols, and the figures may show only those specific details that are pertinent to understanding the embodiments of the present disclosure so as not to obscure the figures with details that will be readily apparent to those skilled in the art having the benefit of the description herein.

### DETAILED DESCRIPTION OF THE DISCLOSURE

For the purpose of promoting an understanding of the principles of the disclosure, reference will now be made to the embodiment illustrated in the figures and specific language will be used to describe them. It will nevertheless be understood that no limitation of the scope of the disclosure is thereby intended. Such alterations and further modifications in the illustrated system, and such further applications of the principles of the disclosure as would normally occur to those skilled in the art are to be construed as being within the scope of the present disclosure. It will be understood by those skilled in the art that the foregoing general description and the following detailed description are exemplary and explanatory of the disclosure and are not intended to be restrictive thereof.

In the present document, the word “exemplary” is used herein to mean “serving as an example, instance, or illustration.” Any embodiment or implementation of the present subject matter described herein as “exemplary” is not necessarily to be construed as preferred or advantageous over other embodiments.

The terms “comprise”, “comprising”, or any other variations thereof, are intended to cover a non-exclusive inclusion, such that one or more devices or sub-systems or elements or structures or components preceded by “comprises . . . a” does not, without more constraints, preclude the existence of other devices, sub-systems, additional sub-modules. Appearances of the phrase “in an embodiment”, “in another embodiment” and similar language throughout this specification may, but not necessarily do, all refer to the same embodiment.

Unless otherwise defined, all technical and scientific terms used herein have the same meaning as commonly understood by those skilled in the art to which this disclosure belongs. The system, methods, and examples provided herein are only illustrative and not intended to be limiting.

A computer system (standalone, client or server computer system) configured by an application may constitute a “module” (or “subsystem”) that is configured and operated to perform certain operations. In one embodiment, the “module” or “subsystem” may be implemented mechanically or electronically, so a module includes dedicated circuitry or logic that is permanently configured (within a special-purpose processor) to perform certain operations. In another embodiment, a “module” or “subsystem” may also comprise programmable logic or circuitry (as encompassed within a general-purpose processor or other programmable processor) that is temporarily configured by software to perform certain operations.

Accordingly, the term “module” or “subsystem” should be understood to encompass a tangible entity, be that an entity that is physically constructed, permanently configured (hardwired) or temporarily configured (programmed) to operate in a certain manner and/or to perform certain operations described herein.

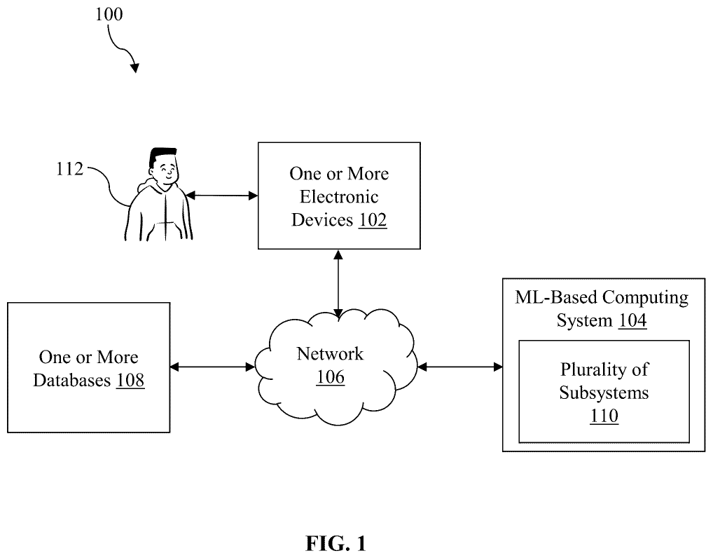

Referring now to the drawings, and more particularly to FIG. 1 through FIG. 9, where similar reference characters denote corresponding features consistently throughout the figures, there are shown preferred embodiments and these embodiments are described in the context of the following exemplary system and/or method.

The present invention with a machine learning based (ML-based) computing system is configured to bridge a gap between data insights and data-driven decision-making. The present invention is configured to allow one or more organizations to run one or more experiments, from diagnostics to prediction and optimization, using a configuration-driven approach. The present invention with the machine learning based (ML-based) computing system is built in Python and leverages one or more existing data assets and AI/ML models within the one or more organizations to provide customized, actionable insights.

FIG. 1 is a block diagram illustrating a computing environment 100 with a machine learning based (ML-based) computing system 104 for generating one or more decisions corresponding to one or more processes in one or more organizations, in accordance with an embodiment of the present disclosure. According to FIG. 1, the computing environment 100 includes one or more electronic devices 102 that are communicatively coupled to the ML-based computing system 104 through a network 106. The one or more electronic devices 102 through which one or more users 112 provide one or more inputs to the ML-based computing system 104.

In an embodiment, the one or more users 112 may include at least one of: one or more deciding authorities, one or more employees, and the like, in the one or more organizations. The present invention is configured to automatically generate/make the one or more decisions for the one or more processes (i.e., one or more studies) by synthesizing at least one of: one or more insights generated from the one or more experiments. The ML-based computing system 104 is initially configured to receive one or more data associated with the one or more experiments corresponding to the one or more processes, from the one or more electronic devices 102 associated with the one or more users 112. In an embodiment, the one or more data may include one or more first data associated with one or more first experiments corresponding to the one or more processes, one or more second data associated with one or more second experiments corresponding to the one or more processes, and one or more third data associated with one or more third experiments corresponding to the one or more processes.

The ML-based computing system 104 is further configured to analyze at least one of: the one or more first data associated with the one or more first experiments, the one or more second data associated with the one or more second experiments, and the one or more third data associated with the one or more third experiments.

The ML-based computing system 104 is further configured to generate one or more second insights associated with the one or more second experiments corresponding to the one or more processes, based on the analyzed one or more second data associated with the one or more second experiments by one or more machine learning models. The ML-based computing system 104 is further configured to generate one or more third insights associated with the one or more third experiments corresponding to the one or more processes, based on the analyzed one or more third data associated with the one or more third experiments by one or more simulation based models.

The ML-based computing system 104 is further configured to synthesize at least one of: the one or more first insights retrieved from the historical data, the one or more second insights generated from the one or more second experiments corresponding to the one or more processes by the one or more machine learning models, and the one or more third insights generated from the one or more third experiments corresponding to the one or more processes by the one or more simulation based models.

The ML-based computing system 104 is further configured to generate the one or more decisions corresponding to the one or more processes based on synthesization of at least one of: the one or more first insights retrieved from the historical data, the one or more second insights generated from the one or more second experiments corresponding to the one or more processes by the one or more machine learning models, and the one or more third insights generated from the one or more third experiments corresponding to the one or more processes by the one or more simulation based models.

The ML-based computing system 104 is further configured to provide an output of the one or more decisions corresponding to the one or more processes to the one or more user interfaces associated with the one or more electronic devices 102 of the one or more users 112 in the one or more organizations.

The ML-based computing system 104 may be hosted on a central server including at least one of: a cloud server or a remote server. In an embodiment, the ML-based computing system 104 may be configured in the one or more electronic devices 102. In an embodiment, the ML-based computing system 104 may include at least one of: a user device, a server computer, a server computer over the network 106, a cloud-based computing system, a cloud-based computing system over the network 106, a distributed computing system, and the like. Further, the network 106 may be at least one of: a Wireless-Fidelity (Wi-Fi) connection, a hotspot connection, a Bluetooth connection, a local area network (LAN), a wide area network (WAN), any other wireless network, and the like. In an embodiment, the one or more electronic devices 102 may include at least one of: a laptop computer, a desktop computer, a tablet computer, a Smartphone, a wearable device, a Smart watch, and the like.

Further, the computing environment 100 includes one or more databases 108 communicatively coupled to the ML-based computing system 104 through the network 106. In an embodiment, the one or more databases 108 include at least one of: one or more relational databases, one or more object-oriented databases, one or more data warehouses, one or more cloud-based databases, and the like. Furthermore, the one or more electronic devices 102 include at least one of: a local browser, a mobile application, and the like.

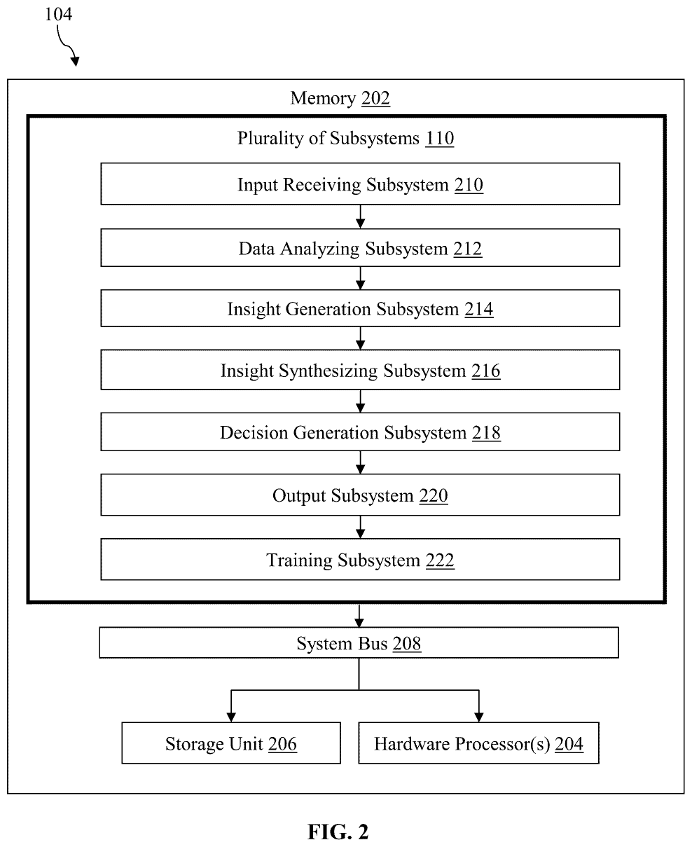

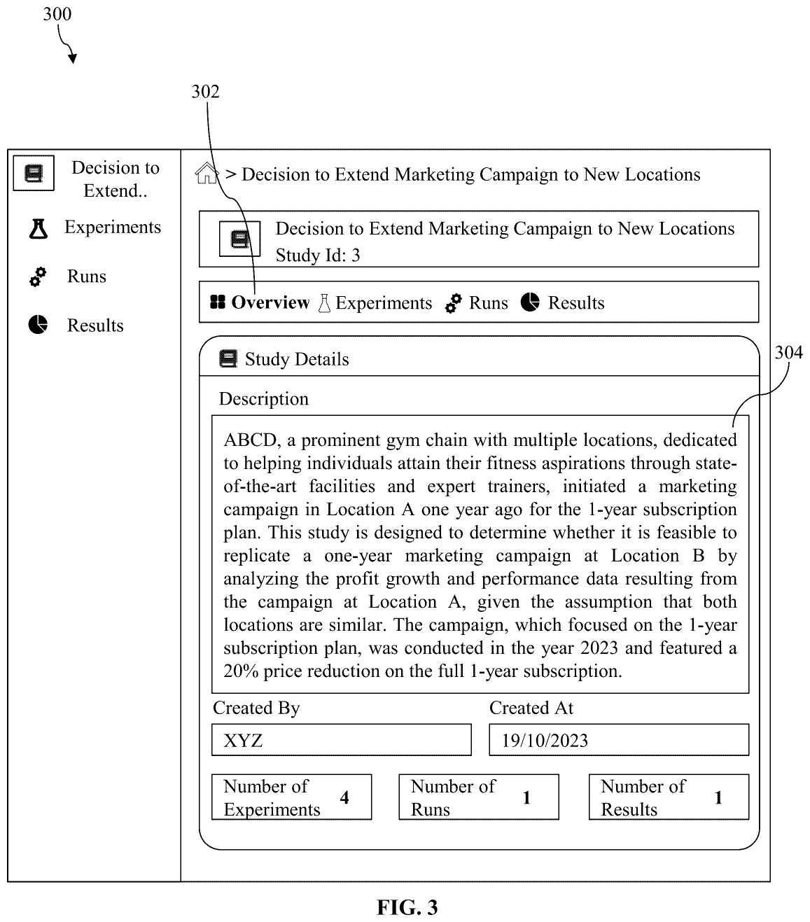

Furthermore, the one or more users 112 may use a web application through the local browser, the mobile application to communicate with the ML-based computing system 104. In an embodiment of the present disclosure, the ML-based computing system 104 includes a plurality of subsystems 110. Details on the plurality of subsystems 110 have been elaborated in subsequent paragraphs of the present description with reference to FIG. 2.

FIG. 2 is a detailed view of the ML-based computing system 104 for generating the one or more decisions corresponding to the one or more processes in the one or more organizations, in accordance with another embodiment of the present disclosure. The ML-based computing system 104 includes a memory 202, one or more hardware processors 204, and a storage unit 206. The memory 202, the one or more hardware processors 204, and the storage unit 206 are communicatively coupled through a system bus 208 or any similar mechanism. The memory 202 includes the plurality of subsystems 110 in the form of programmable instructions executable by the one or more hardware processors 204.

The plurality of subsystems 110 includes an input receiving subsystem 210, a data analyzing subsystem 212, an insight generation subsystem 214, an insight synthesizing subsystem 216, a decision generation subsystem 218, an output subsystem 220, and a training subsystem 222.

The one or more hardware processors 204, as used herein, means any type of computational circuit, including, but not limited to, at least one of: a microprocessor unit, microcontroller, complex instruction set computing microprocessor unit, reduced instruction set computing microprocessor unit, very long instruction word microprocessor unit, explicitly parallel instruction computing microprocessor unit, graphics processing unit, digital signal processing unit, or any other type of processing circuit. The one or more hardware processors 204 may also include embedded controllers, including at least one of: generic or programmable logic devices or arrays, application specific integrated circuits, single-chip computers, and the like.

The memory 202 may be non-transitory volatile memory and non-volatile memory. The memory 202 may be coupled for communication with the one or more hardware processors 204, being a computer-readable storage medium. The one or more hardware processors 204 may execute machine-readable instructions and/or source code stored in the memory 202. A variety of machine-readable instructions may be stored in and accessed from the memory 202. The memory 202 may include any suitable elements for storing data and machine-readable instructions, including at least one of: read only memory, random access memory, erasable programmable read only memory, electrically erasable programmable read only memory, a hard drive, a removable media drive for handling compact disks, digital video disks, diskettes, magnetic tape cartridges, memory cards, and the like. In the present embodiment, the memory 202 includes the plurality of subsystems 110 stored in the form of machine-readable instructions on any of the above-mentioned storage media and may be in communication with and executed by the one or more hardware processors 204.

The storage unit 206 may be a cloud storage, a Structured Query Language (SQL) data store, a noSQL database or a location on a file system directly accessible by the plurality of subsystems 110.

The plurality of subsystems 110 includes the input receiving subsystem 210 that is communicatively connected to the one or more hardware processors 204. The input receiving subsystem 210 is configured to receive the one or more data associated with the one or more experiments corresponding to the one or more processes, from the one or more electronic devices 102 associated with the one or more users 112. In an embodiment, the one or more data may include at least one of: one or more first data associated with the one or more first experiments corresponding to the one or more processes, the one or more second data associated with one or more second experiments corresponding to the one or more processes, and the one or more third data associated with one or more third experiments corresponding to the one or more processes.

In an embodiment, the one or more first data are the historical data including one or more first insights associated with the one or more first experiments corresponding to the one or more processes. In another embodiment, the one or more second data associated with the one or more second experiments including the one or more real time data corresponding to the one or more processes. In an embodiment, the one or more real time data are inputted to the one or more machine learning models to generate the one or more first prediction results associated with the one or more second insights corresponding to the one or more processes. In another embodiment, the one or more third data associated with the one or more third experiments including the one or more real time data corresponding to the one or more processes. In an embodiment, the one or more real time data are inputted to the one or more simulation based models to generate the one or more second prediction results associated with the one or more third insights corresponding to the one or more processes.

The plurality of subsystems 110 further includes the data analyzing subsystem 212 that is communicatively connected to the one or more hardware processors 204. The data analyzing subsystem 212 is configured to analyze at least one of: the one or more first data associated with the one or more first experiments, the one or more second data associated with the one or more second experiments, and the one or more third data associated with the one or more third experiments.

The plurality of subsystems 110 further includes the insight generation subsystem 214 that is communicatively connected to the one or more hardware processors 204. The insight generation subsystem 214 is configured to generate the one or more second insights associated with the one or more second experiments corresponding to the one or more processes, based on the analyzed one or more second data associated with the one or more second experiments by the one or more machine learning models.

For generating the one or more second insights associated with the one or more second experiments corresponding to the one or more processes, the one or more machine learning models in the insight generation subsystem 214 are configured to obtain the analyzed one or more second data associated with the one or more second experiments corresponding to the one or more processes. The one or more machine learning models in the insight generation subsystem 214 are further configured to compare the analyzed one or more second data associated with the one or more second experiments corresponding to the one or more processes, with one or more predetermined data associated with the one or more processes for which the one or more decisions are generated. In an embodiment, the comparison of the analyzed one or more second data associated with the one or more second experiments corresponding to the one or more processes, with the one or more predetermined data associated with the one or more processes comprises determining whether the analyzed one or more second data associated with the one or more second experiments corresponding to the one or more processes reach one or more predefined threshold values associated with the one or more predetermined data associated with the one or more processes, by the one or more machine learning models.

The one or more machine learning models in the insight generation subsystem 214 are further configured to generate the one or more second insights associated with the one or more second experiments corresponding to the one or more processes when the analyzed one or more second data associated with the one or more second experiments corresponding to the one or more processes reach the one or more predefined threshold values associated with the one or more predetermined data associated with the one or more processes. In an embodiment, the one or more machine learning models are trained on the one or more second data to generate the one or more second insights associated with the one or more second experiments corresponding to the one or more processes. In an embodiment, the one or more machine learning models may include at least one of: a regression based machine learning model, a classification based machine learning model, a clustering based machine learning model, a time-series forecasting based machine learning model, a natural language processing (NLP) based machine learning model, a recommendation algorithms, ensemble models, and the like, based on the requirements of study and experiments.

The insight generation subsystem 214 is further configured to generate the one or more third insights associated with the one or more third experiments corresponding to the one or more processes, based on the analyzed one or more third data associated with the one or more third experiments by the one or more simulation based models. For generating the one or more third insights associated with the one or more third experiments corresponding to the one or more processes, the one or more simulation based models in the insight generation subsystem 214 are configured to obtain the analyzed one or more third data associated with the one or more third experiments corresponding to the one or more processes.

The one or more simulation based models in the insight generation subsystem 214 are further configured to process the one or more simulation based models based on the analyzed one or more third data associated with the one or more third experiments corresponding to the one or more processes. The one or more simulation based models in the insight generation subsystem 214 are further configured to generate one or more simulation results associated with the one or more third insights by processing the analyzed one or more third data. The one or more simulation based models in the insight generation subsystem 214 are further configured to validate the generated one or more simulation results associated with the one or more third insights by comparing the generated one or more simulation results associated with the one or more third insights, with one or more actual simulation results associated with one or more actual insights corresponding to the one or more third data.

In an embodiment, the one or more simulation-based models may include at least one of: a data-driven simulation model and a process-driven simulation model. In an embodiment, the data-driven simulation model is configured to utilize one or more techniques including Monte Carlo simulation to thoroughly assess potential outcomes across different experiments. In another embodiment, the process-driven simulation model is configured to incorporate one or more techniques including at least one of: system dynamics, discrete events, agent-based modeling, and the like.

The plurality of subsystems 110 further includes the insight synthesizing subsystem 216 that is communicatively connected to the one or more hardware processors 204. The insight synthesizing subsystem 216 is configured to synthesize at least one of: the one or more first insights retrieved from the historical data, the one or more second insights generated from the one or more second experiments corresponding to the one or more processes by the one or more machine learning models, and the one or more third insights generated from the one or more third experiments corresponding to the one or more processes by the one or more simulation based models.

The plurality of subsystems 110 further includes the decision generation subsystem 218 that is communicatively connected to the one or more hardware processors 204. The decision generation subsystem 218 is configured to generate the one or more decisions corresponding to the one or more processes based on synthesization of at least one of: the one or more first insights retrieved from the historical data, the one or more second insights generated from the one or more second experiments corresponding to the one or more processes by the one or more machine learning models, and the one or more third insights generated from the one or more third experiments corresponding to the one or more processes by the one or more simulation based models. In an embodiment, the generated one or more decisions corresponding to the one or more processes are configured to be stored in the one or more databases 108.

In an embodiment, the generated one or more decisions are dynamically optimized based on one or more feedbacks received on the one or more first data associated with the one or more first experiments using a feedback subsystem. In another embodiment, for dynamically optimizing the generated one or more decisions, the feedback subsystem is configured to validate the one or more feedbacks received on the one or more first data associated with the one or more first experiments, by comparing one or more values associated with the one or more feedbacks with one or more predetermined values. The feedback subsystem is further configured to select the validated one or more feedbacks received on the one or more first data based on the comparison of the one or more values associated with the one or more feedbacks with the one or more predetermined values. The feedback subsystem is further configured to optimize the generated one or more decisions based on the selection of the validated one or more feedbacks received on the one or more first data associated with the one or more first experiments.

In an embodiment, the generated one or more decisions are dynamically optimized by applying the generated one or more third insights as one or more inputs to the one or more simulation based models. In an embodiment, the generated one or more third insights are continuously applied as the one or more inputs until the generated one or more decisions are dynamically optimized.

In an embodiment, the one or more machine learning models are configured to assign one or more weights to the generated one or more decisions corresponding to the one or more processes. The one or more machine learning models are further configured to select an optimal decision corresponding to the one or more processes based on an optimal weight assigned to the generated one or more decisions corresponding to the one or more processes.

The plurality of subsystems 110 further includes the output subsystem 220 that is communicatively connected to the one or more hardware processors 204. The output subsystem 220 is configured to provide the output of the one or more decisions corresponding to the one or more processes to the one or more user interfaces associated with the one or more electronic devices 102 of the one or more users 112 in the one or more organizations.

The plurality of subsystems 110 further includes the training subsystem 222 that is communicatively connected to the one or more hardware processors 204. The training subsystem 222 is configured to train the one or more machine learning models on the one or more second data to generate the one or more second insights associated with the one or more second experiments corresponding to the one or more processes.

For training the one or more machine learning models on the one or more second data, the training subsystem 222 is initially configured to obtain the one or more second data associated with the one or more second experiments corresponding to the one or more processes. The training subsystem 222 is further configured to select one or more features associated with the one or more second data for training the one or more machine learning models based on one or more feature engineering processes. The training subsystem 222 is further configured to train the one or more machine learning models to correlate the one or more features associated with the one or more second data, with one or more prestored results related to the one or more second experiments corresponding to the one or more processes, based on one or more hyperparameters.

The training subsystem 222 is further configured to generate the one or more second insights associated with the one or more second experiments corresponding to the one or more processes based on the trained one or more machine learning models. The training subsystem 222 is further configured to validate the one or more machine learning models based on one or more validation datasets. The training subsystem 222 is further configured to adjust the one or more hyperparameters to fine-tune the one or more machine learning models based on one or more results of validation of the one or more machine learning models. In an embodiment, an optimal machine learning model may be selected to a specific process or use case. Upon training, the selected machine learning model may be packaged and implemented in a repository, accessible through one or more application programming interfaces (APIs) for seamless integration.

FIG. 3 is an exemplary user interface view 300 depicting information 304 associated with the one or more processes (i.e., studies) for which the one or more decisions to be generated, in accordance with an embodiment of the present disclosure. The exemplary user interface view 300 depicts an overview field 302, an experiments field, a run field, and a results field. The overview field 302 shows the information 304 associated with the one or more processes (i.e., studies), based on which the one or more decisions are generated. In other words, the overview field 302 may provide the information 304 about the studies to be conducted, purpose of the studies and focus of the studies.

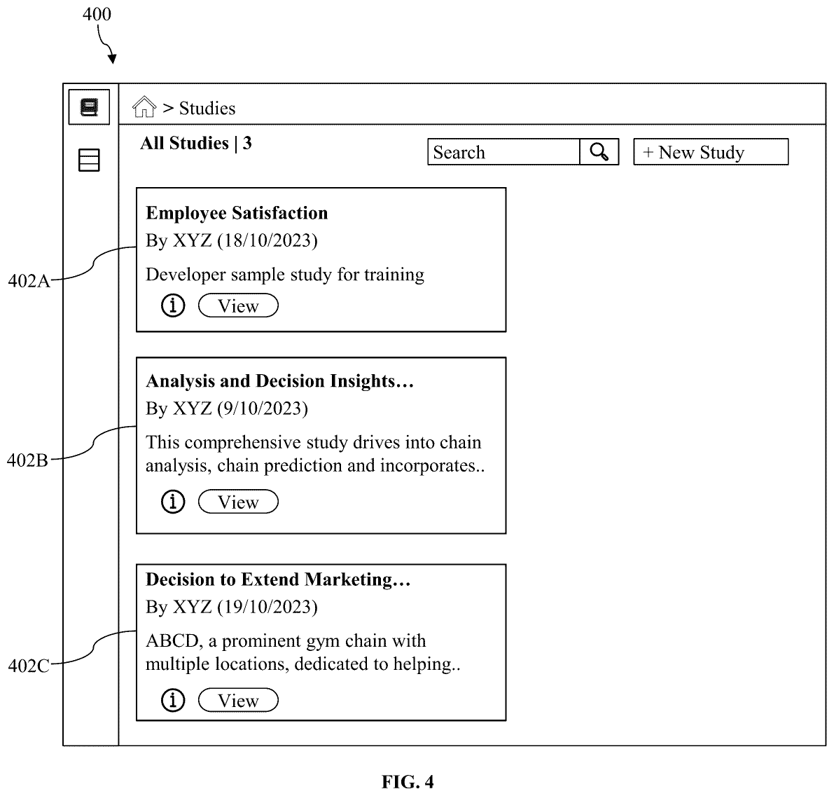

FIG. 4 is an exemplary user interface view 400 depicting the one or more processes (i.e., the studies), in accordance with an embodiment of the present disclosure. The exemplary user interface view 400 depicts the one or more studies 402A-C for which the one or more decisions to be generated. In an embodiment, the one or more studies 402A-C may include one or more corresponding information based on which the one or more decisions are generated.

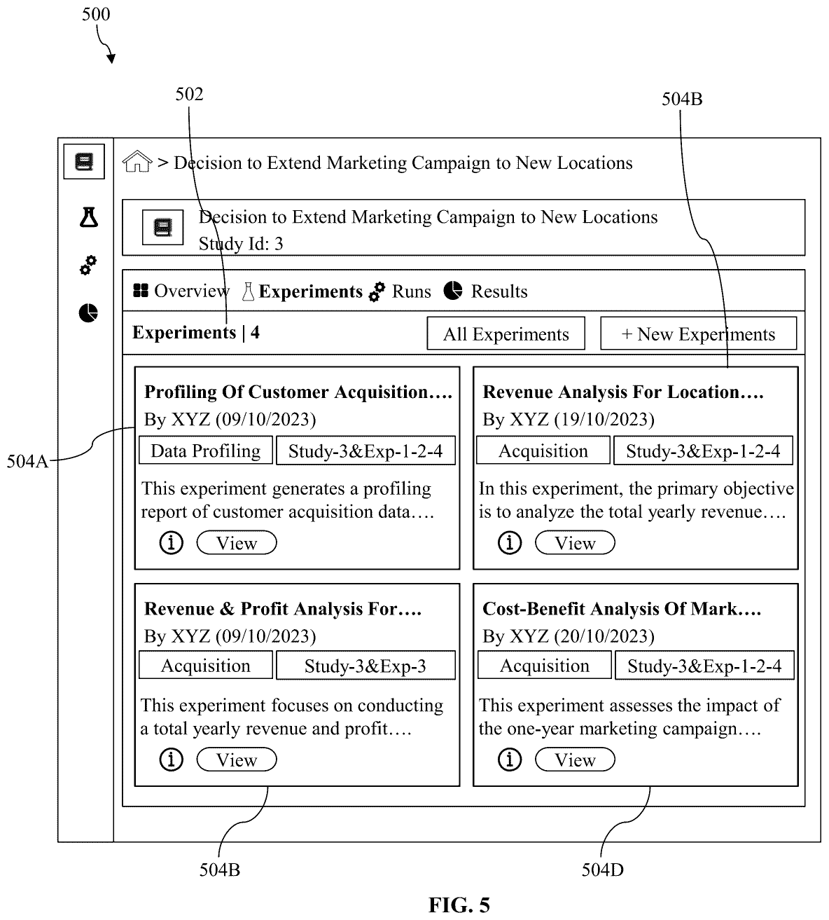

FIG. 5 is an exemplary user interface view 500 depicting one or more experiments 504A-D corresponding to the one or more processes, in accordance with an embodiment of the present disclosure. The exemplary user interface view 500 shows an experiments field 502 including a repository of one or more experiments 504A-D within the one or more studies 402A-C, facilitating organized management of the one or more experiments 504A-D.

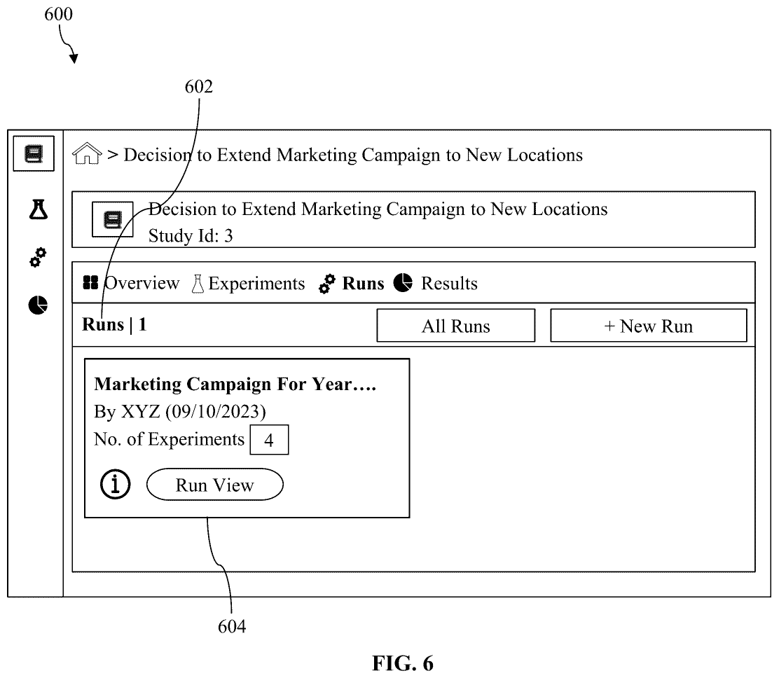

FIG. 6 is an exemplary user interface view 600 depicting the one or more experiments 504A-D running for generating the one or more decisions for the one or more studies (i.e., the one or more processes) 402A-C, in accordance with an embodiment of the present disclosure. The exemplary user interface view 600 shows a run field 602 that is configured to run (shown as 604) the one or more studies 402A-C with the one or more experiments 504A-D for generating the one or more decisions for the one or more studies (i.e., the one or more processes) 402A-C. The run field 602 is configured to encompass a list of runs and the one or more experiments 504A-D within each run, allowing the one or more users 112 to track and manage one or more experiments sessions.

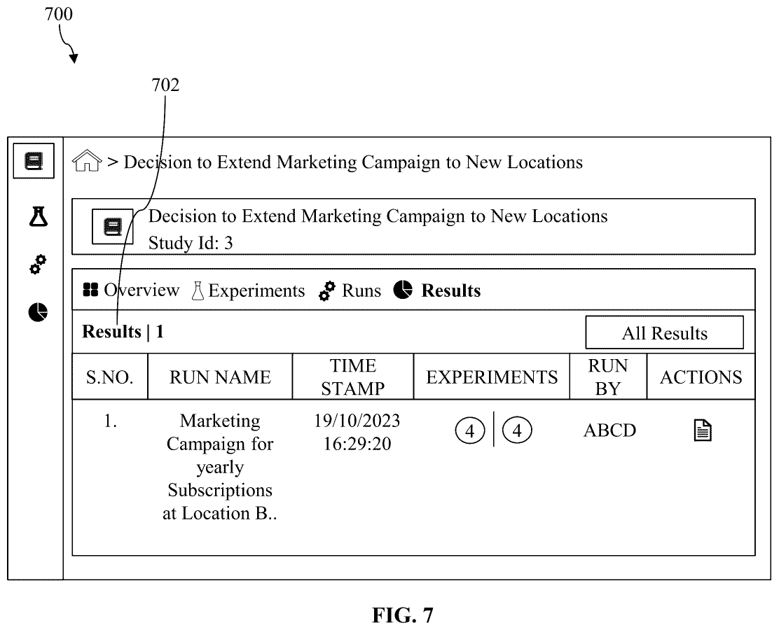

FIG. 7 is an exemplary user interface view 700 depicting one or more results including the one or more decisions for the one or more processes 402A-C based on the one or more experiments 504A-D, in accordance with an embodiment of the present disclosure. The exemplary user interface view 700 shows a results field 702 depicting information associated with at least one of: run name (e.g., marketing campaign for yearly subscriptions at Location B), time stamp (e.g., data and time), the one or more experiments 504A-D, run by (e.g., a person running the study), and one or more actions (e.g., detailed information about the decision). In an embodiment, the results field 702 is configured to display an outcome of the one or more experiments 504A-D upon execution, offering a comprehensive view of the one or more insights generated.

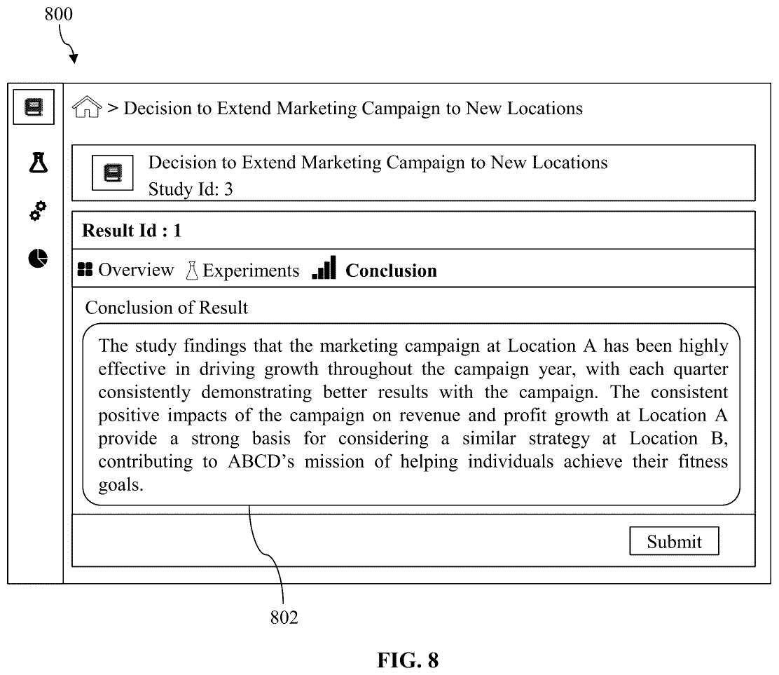

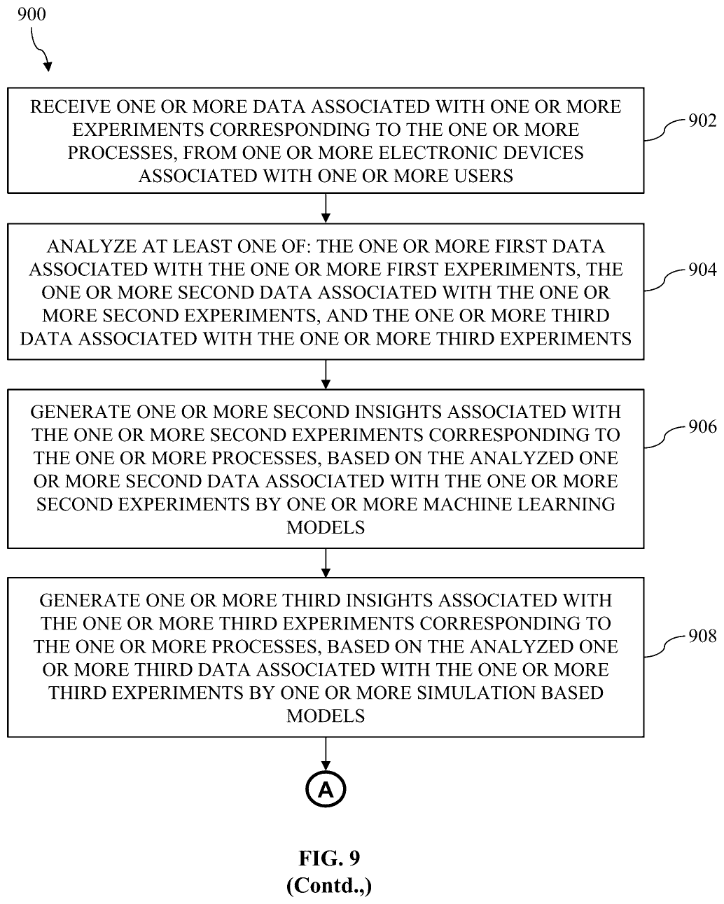

FIG. 8 is an exemplary user interface view 800 depicting detailed information 802 associated with the one or more results including the one or more decisions for the one or more processes 402A-C, in accordance with an embodiment of the present disclosure. The exemplary user interface view 800 shows the detailed information 802 describing the one or more decisions corresponding to the one or more studies 402A-C, for the one or more users 112 in the one or more organizations.

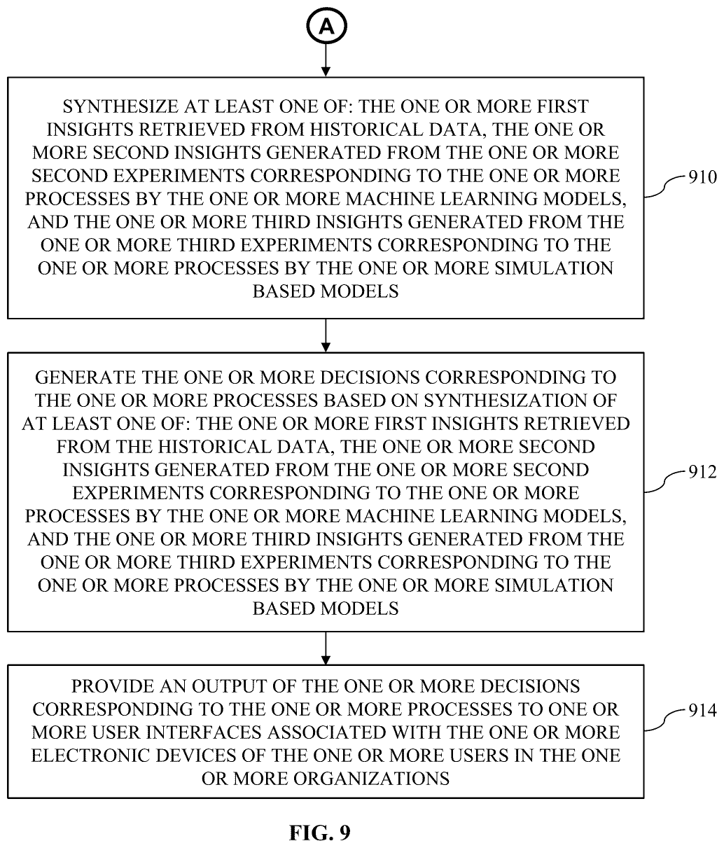

FIG. 9 is a flow chart illustrating a machine-learning based (ML-based) computing method 900 for generating the one or more decisions corresponding to the one or more processes in the one or more organizations, in accordance with an embodiment of the present disclosure. At step 902, the one or more data associated with the one or more experiments corresponding to the one or more processes, are received from the one or more electronic devices 102 associated with the one or more users 112. In an embodiment, the one or more data may include at least one of: the one or more first data associated with the one or more first experiments corresponding to the one or more processes, the one or more second data associated with the one or more second experiments corresponding to the one or more processes, and the one or more third data associated with the one or more third experiments corresponding to the one or more processes.

In an embodiment, the one or more first data are one or more historical data including the one or more first insights associated with the one or more first experiments corresponding to the one or more processes.

At step 904, at least one of: the one or more first data associated with the one or more first experiments, the one or more second data associated with the one or more second experiments, and the one or more third data associated with the one or more third experiments, are analyzed.

At step 906, the one or more second insights associated with the one or more second experiments corresponding to the one or more processes, are generated based on the analyzed one or more second data associated with the one or more second experiments by one or more machine learning models.

At step 908, the one or more third insights associated with the one or more third experiments corresponding to the one or more processes, are generated based on the analyzed one or more third data associated with the one or more third experiments by one or more simulation based models.

At step 910, at least one of: the one or more first insights retrieved from the historical data, the one or more second insights generated from the one or more second experiments corresponding to the one or more processes by the one or more machine learning models, and the one or more third insights generated from the one or more third experiments corresponding to the one or more processes by the one or more simulation based models, are synthesized.

At step 912, the one or more decisions corresponding to the one or more processes are generated based on synthesization of at least one of: the one or more first insights retrieved from the historical data, the one or more second insights generated from the one or more second experiments corresponding to the one or more processes by the one or more machine learning models, and the one or more third insights generated from the one or more third experiments corresponding to the one or more processes by the one or more simulation based models.

At step 914, the output of the one or more decisions corresponding to the one or more processes is provided to the one or more user interfaces associated with the one or more electronic devices 102 of the one or more users 112 in the one or more organizations. In FIG. 9 the circular symbol with “A” written inside is being used as an off-page connector. This is used for indicating that FIG. 9 continues in the next page.

The present invention has following advantages. The ML-based computing system 104 is a versatile experimentation platform designed for universal applicability, spanning across all industries. The ML-based computing system 104 is configured to empower the one or more organizations to conduct a diverse range of experiments, making it invaluable for stakeholders involved in strategic, tactical, and operational decision-making processes.

The present invention with the ML-based computing system 104 is configured to bridge the gap between the data insights and the data-driven decision-making, delivering substantial business value through enhanced decision-making processes. The present invention with the ML-based computing system 104 is further configured to facilitate informed choices through the data-driven decision-making. The present invention with the ML-based computing system 104 is further configured to enable an effortless management and comparison of experiment results for streamlined processes.

The present invention with the ML-based computing system 104 is configured to provide a solution for consistent insights across various experiments. The present invention with the ML-based computing system 104 is configured to foster collaboration among stakeholders involved in the decision-making process for more effective outcomes.

The ML-based computing system 104 includes the user interface that serves as a central hub for effective management and comparison of experiment results. The one or more users 112 may seamlessly add experiment details, study particulars, and the like. The user interface may empower the one or more users 112 to schedule multiple runs, providing a comprehensive overview of the one or more experiments while ensuring consistency in the one or more insights. This intuitive design enhances the user experience, making it a pivotal component for decision-makers.

The present invention with the ML-based computing system 104 is configured to adopt a configuration-driven approach, allowing the one or more users 112 to tailor parameters and thresholds to their specific requirements. This flexibility ensures adaptability across a range of experiments, making it a versatile solution for varied stakeholders. By seamlessly integrating with the existing data assets and AI/ML models within the one or more organizations, the ML-based computing system 104 is configured to streamline the experimentation process. The present invention with the ML-based computing system 104 not only enhances efficiency but also maximizes the utility of pre-existing resources, providing a cohesive environment for experimentation and decision-making.

The ML-based computing system 104 is a fully transparent system that avoids a black box approach and provides clarity in decision-making processes. The ML-based computing system 104 utilizes open-source components, ensuring cost-effectiveness and proprietary application programming interfaces (APIs) to rapidly run the one or more experiments. The one or more experiments are part of a unified platform, bringing together the power of all data-driven decision-making tools and eliminating siloed approaches.

The ML-based computing system 104 has faster implementation and modification capabilities, as the ML-based computing system 104 is configuration-driven and is configured to employ a low-code approach for swift adaptations. The ML-based computing system 104 may include tailored parameters to be provided to the diverse needs of different stakeholders. The ML-based computing system 104 may include a user-friendly interface ensuring ease of use in managing and comparing experiment results. The ML-based computing system 104 is configured to seamlessly integrate with the existing data assets and the AI/ML models for a cohesive environment.

The ML-based computing system 104 is configured to optimize marketing campaigns, to determine optimal locations for rollouts, and to ensure targeted and effective strategies. The ML-based computing system 104 is configured to empower the businesses to optimize pricing strategies through systematic experimentation, allowing the businesses to evaluate different models and structures for maximum profitability. The ML-based computing system 104 is configured to offer a robust solution for personalized user experiences. The ML-based computing system 104 is configured to facilitate systematic experimentation of various consumer insights and recommendations derived from data and ML models, ensuring businesses deliver compelling and tailored experiences to the one or more users 112.

The written description describes the subject matter herein to enable any person skilled in the art to make and use the embodiments. The scope of the subject matter embodiments is defined by the claims and may include other modifications that occur to those skilled in the art. Such other modifications are intended to be within the scope of the claims if they have similar elements that do not differ from the literal language of the claims or if they include equivalent elements with insubstantial differences from the literal language of the claims.

The embodiments herein can comprise hardware and software elements. The embodiments that are implemented in software include but are not limited to, firmware, resident software, microcode, etc. The functions performed by various modules described herein may be implemented in other modules or combinations of other modules. For the purposes of this description, a computer-usable or computer-readable medium can be any apparatus that can comprise, store, communicate, propagate, or transport the program for use by or in connection with the instruction execution system, apparatus, or device.

The medium can be an electronic, magnetic, optical, electromagnetic, infrared, or semiconductor system (or apparatus or device) or a propagation medium. Examples of a computer-readable medium include a semiconductor or solid-state memory, magnetic tape, a removable computer diskette, a random-access memory (RAM), a read-only memory (ROM), a rigid magnetic disk and an optical disk. Current examples of optical disks include compact disk-read only memory (CD-ROM), compact disk-read/write (CD-R/W) and DVD.

Input/output (I/O) devices (including but not limited to keyboards, displays, pointing devices, etc.) can be coupled to the ML-based computing system 104 either directly or through intervening I/O controllers. Network adapters may also be coupled to the ML-based computing system 104 to enable the data processing system to become coupled to other data processing systems or remote printers or storage devices through intervening private or public networks. Modems, cable modem and Ethernet cards are just a few of the currently available types of network adapters.

A representative hardware environment for practicing the embodiments may include a hardware configuration of an information handling/ML-based computing system 104 in accordance with the embodiments herein. The ML-based computing system 104 herein comprises at least one processor or central processing unit (CPU). The CPUs are interconnected via the system bus 208 to various devices including at least one of: a random-access memory (RAM), read-only memory (ROM), and an input/output (I/O) adapter. The I/O adapter can connect to peripheral devices, including at least one of: disk units and tape drives, or other program storage devices that are readable by the ML-based computing system 104. The ML-based computing system 104 can read the inventive instructions on the program storage devices and follow these instructions to execute the methodology of the embodiments herein.

The ML-based computing system 104 further includes a user interface adapter that connects a keyboard, mouse, speaker, microphone, and/or other user interface devices including a touch screen device (not shown) to the bus to gather user input. Additionally, a communication adapter connects the bus to a data processing network, and a display adapter connects the bus to a display device which may be embodied as an output device including at least one of: a monitor, printer, or transmitter, for example.

A description of an embodiment with several components in communication with each other does not imply that all such components are required. On the contrary, a variety of optional components are described to illustrate the wide variety of possible embodiments of the invention. When a single device or article is described herein, it will be apparent that more than one device/article (whether or not they cooperate) may be used in place of a single device/article. Similarly, where more than one device or article is described herein (whether or not they cooperate), it will be apparent that a single device/article may be used in place of the more than one device or article, or a different number of devices/articles may be used instead of the shown number of devices or programs. The functionality and/or the features of a device may be alternatively embodied by one or more other devices which are not explicitly described as having such functionality/features. Thus, other embodiments of the invention need not include the device itself.

The illustrated steps are set out to explain the exemplary embodiments shown, and it should be anticipated that ongoing technological development will change the manner in which particular functions are performed. These examples are presented herein for purposes of illustration, and not limitation. Further, the boundaries of the functional building blocks have been arbitrarily defined herein for the convenience of the description. Alternative boundaries can be defined so long as the specified functions and relationships thereof are appropriately performed. Alternatives (including equivalents, extensions, variations, deviations, etc., of those described herein) will be apparent to persons skilled in the relevant art(s) based on the teachings contained herein. Such alternatives fall within the scope and spirit of the disclosed embodiments. Also, the words “comprising,” “having,” “containing,” and “including,” and other similar forms are intended to be equivalent in meaning and be open-ended in that an item or items following any one of these words is not meant to be an exhaustive listing of such item or items or meant to be limited to only the listed item or items. It must also be noted that as used herein and in the appended claims, the singular forms “a,” “an,” and “the” include plural references unless the context clearly dictates otherwise.

Finally, the language used in the specification has been principally selected for readability and instructional purposes, and it may not have been selected to delineate or circumscribe the inventive subject matter. It is therefore intended that the scope of the invention be limited not by this detailed description, but rather by any claims that are issued on an application based here on. Accordingly, the embodiments of the present invention are intended to be illustrative, but not limiting, of the scope of the invention, which is set forth in the following claims.

What is claimed is:

1. A machine learning based (ML-based) computing system for generating one or more decisions corresponding to one or more processes in one or more organizations, the machine learning based (ML-based) computing system comprising:
one or more hardware processors;
a memory coupled to the one or more hardware processors, wherein the memory comprises a plurality of subsystems in form of programmable instructions executable by the one or more hardware processors, and wherein the plurality of subsystems comprises:
an input receiving subsystem configured to receive one or more data associated with one or more experiments corresponding to the one or more processes, from one or more electronic devices associated with one or more users,
wherein the one or more data comprise at least one of: one or more first data associated with one or more first experiments corresponding to the one or more processes, one or more second data associated with one or more second experiments corresponding to the one or more processes, and one or more third data associated with one or more third experiments corresponding to the one or more processes, and
wherein the one or more first data are historical data comprising one or more first insights associated with the one or more first experiments corresponding to the one or more processes;
a data analyzing subsystem configured to analyze at least one of: the one or more first data associated with the one or more first experiments, the one or more second data associated with the one or more second experiments, and the one or more third data associated with the one or more third experiments;
an insight generation subsystem configured to:
generate one or more second insights associated with the one or more second experiments corresponding to the one or more processes, based on the analyzed one or more second data associated with the one or more second experiments by one or more machine learning models; and
generate one or more third insights associated with the one or more third experiments corresponding to the one or more processes, based on the analyzed one or more third data associated with the one or more third experiments by one or more simulation based models;
an insight synthesizing subsystem configured to synthesize at least one of: the one or more first insights retrieved from the historical data, the one or more second insights generated from the one or more second experiments corresponding to the one or more processes by the one or more machine learning models, and the one or more third insights generated from the one or more third experiments corresponding to the one or more processes by the one or more simulation based models;
a decision generation subsystem configured to generate the one or more decisions corresponding to the one or more processes based on synthesization of at least one of: the one or more first insights retrieved from the historical data, the one or more second insights generated from the one or more second experiments corresponding to the one or more processes by the one or more machine learning models, and the one or more third insights generated from the one or more third experiments corresponding to the one or more processes by the one or more simulation based models; and
an output subsystem configured to provide an output of the one or more decisions corresponding to the one or more processes to one or more user interfaces associated with the one or more electronic devices of the one or more users in the one or more organizations.

2. The machine-learning based (ML-based) computing system of claim 1, wherein:
the one or more second data associated with the one or more second experiments comprise one or more real time data corresponding to the one or more processes, wherein the one or more real time data are inputted to the one or more machine learning models to generate one or more first prediction results associated with the one or more second insights corresponding to the one or more processes; and
the one or more third data associated with the one or more third experiments comprise the one or more real time data corresponding to the one or more processes, wherein the one or more real time data are inputted to the one or more simulation based models to generate one or more second prediction results associated with the one or more third insights corresponding to the one or more processes.

3. The machine-learning based (ML-based) computing system of claim 1, wherein in generating the one or more second insights associated with the one or more second experiments corresponding to the one or more processes, the one or more machine learning models in the insight generation subsystem are configured to:
obtain the analyzed one or more second data associated with the one or more second experiments corresponding to the one or more processes;
compare the analyzed one or more second data associated with the one or more second experiments corresponding to the one or more processes, with one or more predetermined data associated with the one or more processes for which the one or more decisions are generated,
wherein the comparison of the analyzed one or more second data associated with the one or more second experiments corresponding to the one or more processes, with the one or more predetermined data associated with the one or more processes comprises determining whether the analyzed one or more second data associated with the one or more second experiments corresponding to the one or more processes reach one or more predefined threshold values associated with the one or more predetermined data associated with the one or more processes, by the one or more machine learning models; and
generate the one or more second insights associated with the one or more second experiments corresponding to the one or more processes when the analyzed one or more second data associated with the one or more second experiments corresponding to the one or more processes reach the one or more predefined threshold values associated with the one or more predetermined data associated with the one or more processes.

4. The machine-learning based (ML-based) computing system of claim 1, wherein in generating the one or more third insights associated with the one or more third experiments corresponding to the one or more processes, the one or more simulation based models in the insight generation subsystem are configured to:
obtain the analyzed one or more third data associated with the one or more third experiments corresponding to the one or more processes;
process the one or more simulation based models based on the analyzed one or more third data associated with the one or more third experiments corresponding to the one or more processes;
generate one or more simulation results associated with the one or more third insights by processing the analyzed one or more third data; and
validate the generated one or more simulation results associated with the one or more third insights by comparing the generated one or more simulation results associated with the one or more third insights, with one or more actual simulation results associated with one or more actual insights corresponding to the one or more third data.

5. The machine-learning based (ML-based) computing system of claim 1, wherein the one or more machine learning models are further configured to:
assign one or more weights to the generated one or more decisions corresponding to the one or more processes; and
select an optimal decision corresponding to the one or more processes based on an optimal weight assigned to the generated one or more decisions corresponding to the one or more processes.

6. The machine-learning based (ML-based) computing system of claim 1, further comprising a training subsystem configured to train the one or more machine learning models on the one or more second data to generate the one or more second insights associated with the one or more second experiments corresponding to the one or more processes,
wherein in training the one or more machine learning models on the one or more second data for generating the one or more comprises second insights associated with the one or more second experiments corresponding to the one or more processes, the training subsystem is configured to:
obtain the one or more second data associated with the one or more second experiments corresponding to the one or more processes;
select one or more features associated with the one or more second data for training the one or more machine learning models based on one or more feature engineering processes;
train the one or more machine learning models to correlate the one or more features associated with the one or more second data, with one or more prestored results related to the one or more second experiments corresponding to the one or more processes, based on one or more hyperparameters;
generate the one or more second insights associated with the one or more second experiments corresponding to the one or more processes based on the trained one or more machine learning models;
validate the one or more machine learning models based on one or more validation datasets; and
adjust the one or more hyperparameters to fine-tune the one or more machine learning models based on one or more results of validation of the one or more machine learning models.

7. The machine-learning based (ML-based) computing system of claim 1, wherein the generated one or more decisions corresponding to the one or more processes are configured to be stored in one or more databases.

8. The machine-learning based (ML-based) computing system of claim 1, wherein:
the generated one or more decisions are dynamically optimized based on one or more feedbacks received on the one or more first data associated with the one or more first experiments using a feedback subsystem,
wherein in dynamically optimizing the generated one or more decisions, the feedback subsystem is configured to:
validate the one or more feedbacks received on the one or more first data associated with the one or more first experiments, by comparing one or more values associated with the one or more feedbacks with one or more predetermined values;
select the validated one or more feedbacks received on the one or more first data based on the comparison of the one or more values associated with the one or more feedbacks with the one or more predetermined values; and
optimize the generated one or more decisions based on the selection of the validated one or more feedbacks received on the one or more first data associated with the one or more first experiments.

9. The machine-learning based (ML-based) computing system of claim 1, wherein the generated one or more decisions are dynamically optimized by applying the generated one or more third insights as one or more inputs to the one or more simulation based models, and wherein the generated one or more third insights are continuously applied as the one or more inputs until the generated one or more decisions are dynamically optimized.

10. A machine learning based (ML-based) computing method for generating one or more decisions corresponding to one or more processes in one or more organizations, the machine learning based (ML-based) computing method comprising:
receiving, by one or more hardware processors, one or more data associated with one or more experiments corresponding to the one or more processes, from one or more electronic devices associated with one or more users,
wherein the one or more data comprise at least one of: one or more first data associated with one or more first experiments corresponding to the one or more processes, one or more second data associated with one or more second experiments corresponding to the one or more processes, and one or more third data associated with one or more third experiments corresponding to the one or more processes, and
wherein the one or more first data are one or more historical data comprising one or more first insights associated with the one or more first experiments corresponding to the one or more processes;
analyzing, by the one or more hardware processors, at least one of: the one or more first data associated with the one or more first experiments, the one or more second data associated with the one or more second experiments, and the one or more third data associated with the one or more third experiments;
generating, by the one or more hardware processors, one or more second insights associated with the one or more second experiments corresponding to the one or more processes, based on the analyzed one or more second data associated with the one or more second experiments by one or more machine learning models;
generating, by the one or more hardware processors, one or more third insights associated with the one or more third experiments corresponding to the one or more processes, based on the analyzed one or more third data associated with the one or more third experiments by one or more simulation based models;
synthesizing, by the one or more hardware processors, at least one of: the one or more first insights retrieved from the historical data, the one or more second insights generated from the one or more second experiments corresponding to the one or more processes by the one or more machine learning models, and the one or more third insights generated from the one or more third experiments corresponding to the one or more processes by the one or more simulation based models;
generating, by the one or more hardware processors, the one or more decisions corresponding to the one or more processes based on synthesization of at least one of: the one or more first insights retrieved from the historical data, the one or more second insights generated from the one or more second experiments corresponding to the one or more processes by the one or more machine learning models, and the one or more third insights generated from the one or more third experiments corresponding to the one or more processes by the one or more simulation based models; and
providing, by the one or more hardware processors, an output of the one or more decisions corresponding to the one or more processes to one or more user interfaces associated with the one or more electronic devices of the one or more users in the one or more organizations.

11. The machine-learning based (ML-based) computing method of claim 10, wherein:
the one or more second data associated with the one or more second experiments comprise one or more real time data corresponding to the one or more processes, wherein the one or more real time data are inputted to the one or more machine learning models to generate one or more first prediction results associated with the one or more second insights corresponding to the one or more processes; and
the one or more third data associated with the one or more third experiments comprise the one or more real time data corresponding to the one or more processes, wherein the one or more real time data are inputted to the one or more simulation based models to generate one or more second prediction results associated with the one or more third insights corresponding to the one or more processes.

12. The machine-learning based (ML-based) computing method of claim 10, wherein generating, by the one or more machine learning models, the one or more second insights associated with the one or more second experiments corresponding to the one or more processes, comprises:
obtaining, by the one or more hardware processors, the analyzed one or more second data associated with the one or more second experiments corresponding to the one or more processes;
comparing, by the one or more hardware processors, the analyzed one or more second data associated with the one or more second experiments corresponding to the one or more processes, with one or more predetermined data associated with the one or more processes for which the one or more decisions are generated,
wherein comparing the analyzed one or more second data associated with the one or more second experiments corresponding to the one or more processes, with the one or more predetermined data associated with the one or more processes comprises determining, by the one or more hardware processors, whether the analyzed one or more second data associated with the one or more second experiments corresponding to the one or more processes reach one or more predefined threshold values associated with the one or more predetermined data associated with the one or more processes, by the one or more machine learning models; and
generating, by the one or more hardware processors, the one or more second insights associated with the one or more second experiments corresponding to the one or more processes when the analyzed one or more second data associated with the one or more second experiments corresponding to the one or more processes reach the one or more predefined threshold values associated with the one or more predetermined data associated with the one or more processes.

13. The machine-learning based (ML-based) computing method of claim 10, wherein generating, by the one or more simulation based tools, the one or more third insights associated with the one or more third experiments corresponding to the one or more processes, comprises:
obtaining, by the one or more hardware processors, the analyzed one or more third data associated with the one or more third experiments corresponding to the one or more processes;
processing, by the one or more hardware processors, the one or more simulation based models based on the analyzed one or more third data associated with the one or more third experiments corresponding to the one or more processes;
generating, by the one or more hardware processors, one or more simulation results associated with the one or more third insights by processing the analyzed one or more third data; and
validating, by the one or more hardware processors, the generated one or more simulation results associated with the one or more third insights by comparing the generated one or more simulation results associated with the one or more third insights, with one or more actual simulation results associated with one or more actual insights corresponding to the one or more third data.

14. The machine-learning based (ML-based) computing method of claim 10, further comprising:
assigning, by the one or more hardware processors, one or more weights to the generated one or more decisions corresponding to the one or more processes based on the one or more machine learning models; and
selecting, by the one or more hardware processors, an optimal decision corresponding to the one or more processes based on an optimal weight assigned to the generated one or more decisions corresponding to the one or more processes based on the one or more machine learning models.

15. The machine-learning based (ML-based) computing method of claim 10, further comprising training, by the one or more hardware processors, the one or more machine learning models to generate the one or more second insights associated with the one or more second experiments corresponding to the one or more processes,
wherein training the one or more machine learning models on the one or more second data comprises:
obtaining, by the one or more hardware processors, the one or more second data associated with the one or more second experiments corresponding to the one or more processes;
selecting, by the one or more hardware processors, one or more features associated with the one or more second data for training the one or more machine learning models based on one or more feature engineering processes;
training, by the one or more hardware processors, the one or more machine learning models to correlate the one or more features associated with the one or more second data, with one or more prestored results related to the one or more second experiments corresponding to the one or more processes, based on one or more hyperparameters;
generating, by the one or more hardware processors, the one or more second insights associated with the one or more second experiments corresponding to the one or more processes based on the trained one or more machine learning models;
validating, by the one or more hardware processors, the one or more machine learning models based on one or more validation datasets; and
adjusting, by the one or more hardware processors, the one or more hyperparameters to fine-tune the one or more machine learning models based on one or more results of validation of the one or more machine learning models.

16. The machine-learning based (ML-based) computing method of claim 10, further comprising storing, by the one or more hardware processors, the generated one or more decisions corresponding to the one or more processes in one or more databases.

17. The machine-learning based (ML-based) computing method of claim 10, further comprising dynamically optimizing, by the one or more hardware processors, the generated one or more decisions based on one or more feedbacks received on the one or more first data associated with the one or more first experiments using a feedback subsystem,
wherein dynamically optimizing the generated one or more decisions using the feedback subsystem comprises:
validating, by the one or more hardware processors, the one or more feedbacks received on the one or more first data associated with the one or more first experiments, by comparing one or more values associated with the one or more feedbacks with one or more predetermined values;
selecting, by the one or more hardware processors, the validated one or more feedbacks received on the one or more first data based on the comparison of the one or more values associated with the one or more feedbacks with the one or more predetermined values; and
optimizing, by the one or more hardware processors, the generated one or more decisions based on the selection of the validated one or more feedbacks received on the one or more first data associated with the one or more first experiments.

18. The machine-learning based (ML-based) computing method of claim 10, further comprising dynamically optimizing, by the one or more hardware processors, the generated one or more decisions by applying the generated one or more third insights as one or more inputs to the one or more simulation based models,
wherein the generated one or more third insights are continuously applied as the one or more inputs until the generated one or more decisions are dynamically optimized.

19. A non-transitory computer-readable storage medium having instructions stored therein that when executed by one or more hardware processors, cause the one or more hardware processors to execute operations of:
receiving one or more data associated with one or more experiments corresponding to the one or more processes, from one or more electronic devices associated with one or more users,
wherein the one or more data comprise at least one of: one or more first data associated with one or more first experiments corresponding to the one or more processes, one or more second data associated with one or more second experiments corresponding to the one or more processes, and one or more third data associated with one or more third experiments corresponding to the one or more processes, and
wherein the one or more first data are one or more historical data comprising one or more first insights associated with the one or more first experiments corresponding to the one or more processes;
analyzing at least one of: the one or more first data associated with the one or more first experiments, the one or more second data associated with the one or more second experiments, and the one or more third data associated with the one or more third experiments;
generating one or more second insights associated with the one or more second experiments corresponding to the one or more processes, based on the analyzed one or more second data associated with the one or more second experiments by one or more machine learning models;
generating one or more third insights associated with the one or more third experiments corresponding to the one or more processes, based on the analyzed one or more third data associated with the one or more third experiments by one or more simulation based models;
synthesizing at least one of: the one or more first insights retrieved from the historical data, the one or more second insights generated from the one or more second experiments corresponding to the one or more processes by the one or more machine learning models, and the one or more third insights generated from the one or more third experiments corresponding to the one or more processes by the one or more simulation based models;
generating the one or more decisions corresponding to the one or more processes based on synthesization of at least one of: the one or more first insights retrieved from the historical data, the one or more second insights generated from the one or more second experiments corresponding to the one or more processes by the one or more machine learning models, and the one or more third insights generated from the one or more third experiments corresponding to the one or more processes by the one or more simulation based models; and
providing an output of the one or more decisions corresponding to the one or more processes to one or more user interfaces associated with the one or more electronic devices of the one or more users in the one or more organizations.

20. The non-transitory computer-readable storage medium of claim 19, wherein generating, by the one or more machine learning models, the one or more second insights associated with the one or more second experiments corresponding to the one or more processes, comprises:
obtaining the analyzed one or more second data associated with the one or more second experiments corresponding to the one or more processes;
comparing the analyzed one or more second data associated with the one or more second experiments corresponding to the one or more processes, with one or more predetermined data associated with the one or more processes for which the one or more decisions are generated,
wherein comparing the analyzed one or more second data associated with the one or more second experiments corresponding to the one or more processes, with the one or more predetermined data associated with the one or more processes comprises determining, by the one or more hardware processors, whether the analyzed one or more second data associated with the one or more second experiments corresponding to the one or more processes reach one or more predefined threshold values associated with the one or more predetermined data associated with the one or more processes, by the one or more machine learning models; and
generating the one or more second insights associated with the one or more second experiments corresponding to the one or more processes when the analyzed one or more second data associated with the one or more second experiments corresponding to the one or more processes reach the one or more predefined threshold values associated with the one or more predetermined data associated with the one or more processes.
